(19) United States
(12) Patent Application Publication
(10) Pub. No.: US 2016/0217443 A1
(43) Pub. Date: Jul. 28, 2016

(54) DIGITAL RIGHTS MANAGEMENT SYSTEM PROVIDING TRIAL USE AND FACILITATING PURCHASE OF MANAGED DOCUMENTS

(71) Applicant: KONICA MINOLTA LABORATORY U.S.A., INC., San Mateo, CA (US)

(72) Inventor: Rabindra Pathak, San Jose, CA (US)

(73) Assignee: KONICA MINOLTA LABORATORY U.S.A., INC., San Mateo, CA (US)

(21) Appl. No.: 14/607,832

(22) Filed: Jan. 28, 2015

(51) Int. Cl. G06Q 20/12; G06Q 50/18

(52) U.S. Cl. CPC G06Q 20/1235; G06Q 20/127; G06Q 50/184

(57) ABSTRACT

A digital rights management method provides effective enforcement of purchase requirements to prevent users from accessing documents before purchasing the rights, and also provides the users with limited trial access to review the document before purchase. A digital rights management server maintains a database with information regarding users' payment status with respect to documents and their trial access status with respect to unpaid documents. Various trial modes may be implemented, including a “trial period” mode, a “number of attempts to open” mode, and a “summary view” mode. When a user attempts to access a document, the application on the client computer transmits a request to the server, and the server determines whether the user has paid for the document, or whether he should be given trial access, and transmits a reply to the client accordingly. The reply may include an invitation to pay for the document.

### BACKGROUND OF THE INVENTION

1. Field of the Invention

This invention relates to a digital rights management system, and in particular, it relates to a digital rights management system that allows for trial use of managed documents and monitors user purchase of digital rights to such documents.

2. Description of Related Art

Documents traditionally available only in hard copies are increasingly also available in digital copies. In fact many documents nowadays are prepared, generated, stored, distributed, accessed, read or otherwise used electronically in digital file formats such as the Portable Document Format (PDF). With the wide use of digital documents and digital document processing, digital rights management systems (“DRM” or “RMS”) are increasingly implemented to control user access and prevent unauthorized use of digital documents. The rights involved in using a digital document may include the right to view (or “read”) the digital document, the right to edit (or “write”) the digital document, the right to print the digital document in hard copies, the right to copy the digital document, etc. A user may access a digital document by acquiring (or being assigned) one or more of these rights.

DRM systems are generally implemented for managing users' rights to the digital documents stored in the systems. In a current DRM system, each digital document is associated with a rights management policy (or simply referred to as policy in this disclosure) that specifies which user has what rights to the document, as well as other parameters relating to access rights. Many such policies are stored in a DRM server (also called RMS server), for example in a policy table shown in FIG. 1A. The server also stores a database table that associates each document (e.g. by a unique ID, referred to as document ID or license ID) with a policy (e.g. by policy ID). An example of such a table, referred to as document-policy association table in this disclosure, is shown in FIG. 1B. Each digital document may also have metadata that contains the document ID.

When a user attempts to access a document (either a document residing on a server or a document that has been downloaded or copied to the user's computer) using an application program such as Adobe™ Reader, the application program contacts the RMS server to request permission. The server determines whether the requesting user has the right to access the document in the attempted manner (view, edit, print, etc.), by determining the policy associated with the document and then referring to the content of that policy. The server then transmits an appropriate reply to the application program to grant or deny the access. If access is granted, the server's reply may contain a decryption key to decrypt the document.

The description herein of the structures, functions, interfaces and other relevant features, such as digital rights policies, application programming interface (API) for rights management and policies, etc., of existing DRM systems may at times incorporates, references or otherwise uses certain information, documents and materials from publicly and readily available and accessible public information, e.g., for Adobe™ LiveCycle™: “Rights Management” (URL http://help.adobe.com/en_US/livecycle/10.0/Overview/WS92d06802c76abadb2c8525912ddcb9a ad9-7ff8.html), “Programmatically applying policies (a subsection of ‘Rights Management’)”, (URL http://help.adobe.com/en_US/livecycle/10.0/Overview/WSb96e41f8a4ca47a9-4882aeb5131190eddba-8000.html), “LiveCycle® ES Java™ API Reference” (URL http://livedocs.adobe.com/livecycle/es/sdkHelp/programmer/javadoc/index.html), etc. The Microsoft™ ADRMS system is also a digital rights management system.

### SUMMARY

The present invention is directed to a DRM method and related apparatus that substantially obviates one or more of the problems due to limitations and disadvantages of the related art.

An object of the present invention is to effectively enforce purchase requirements in a DRM system.

Another object of the present invention is to provide trial use to users to allow limited access to a document before they purchase the document.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a digital rights management method implemented in a server computer for managing access to digital documents, which includes: (a) storing and updating user payment and trial status data, which indicates, for each of a plurality of digital documents with respect to one or more of a plurality of users, whether each user has purchased access rights to the document, whether one or more trial modes are available to the user and if available, whether any trial access right remains for the user under the available trial mode; (b) receiving a authorization request from a client computer containing a user ID of a user and a document ID of a document requested to be accessed by the user; (c) determining whether the user has purchased access rights to the document by referring to the user payment and trial status data using the document ID and the user ID in the authorization request; (d) if the user has purchased access rights to the document, transmitting a reply to the client to grant access to the document; (e) if the user has not purchased access rights to the document, determining whether one or more of the trial modes are available to the user and if available, whether any trial access right remains for the user under the available trial mode; (e) if one or more of the trial modes are available to the user and some trial access right remains for the user, transmitting a reply to the client to grant a right to the document permitted under the available trial mode; and (f) if no trial mode is available to the user or no trial access right remains for the user, transmitting a reply to the client to display to the user an invitation to purchase access rights to the document.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1A shows an exemplary policy table stored in a conventional DRM system.

FIG. 1B shows an exemplary document-policy association table stored in the conventional DRM system.

FIG. 2 schematically illustrates a DRM system including an RMS server and a user computer (client) according to an embodiment of the present invention.

FIG. 3 shows a user payment and trial status table stored in the RMS server of the system of FIG. 2.

FIG. 4A schematically illustrates a DRM method executed by the RMS server according to an embodiment of the present invention.

FIG. 4B schematically illustrates a DRM method executed by the user computer according to the embodiment.

### DETAILED DESCRIPTION OF PREFERRED EMBODIMENTS

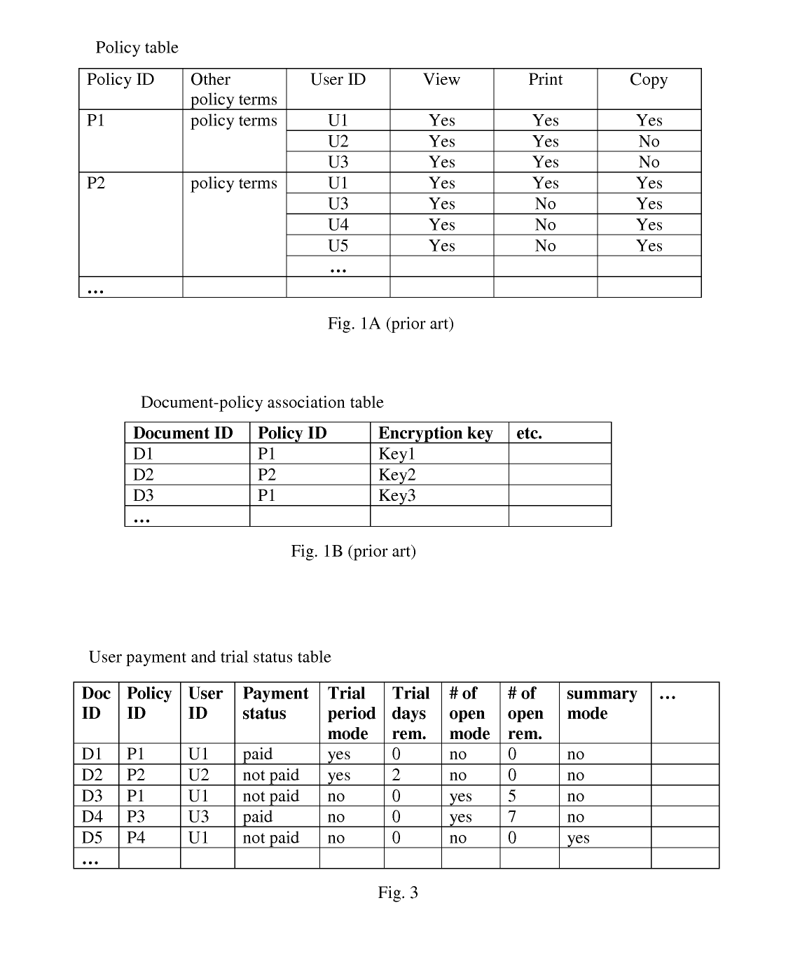

A problem exists in the conventional DRM system described in the Background section, which may result in a user being granted access to a document before the user properly acquires (e.g. purchases) the rights. For example, assume that in the document-policy association table on the RMS server, a document D1 is associated with a rights management policy P1 (see example in FIG. 1B). Assume that a user U1 purchases rights to use document D1. As a result, user U1 is added to the policy P1 which is associated with document D1; i.e., policy P1 now specifies that user U1 has certain specified rights to use documents associated with this policy (see example in FIG. 1A). In this conventional DRM system, different documents may be associated with the same rights management policy. For example, as shown in FIG. 1B, documents D1 and D3 are both associated with policy P1. As a result, if user U1 is added to policy P1 when he purchases document D1, then the DRM system will allow user U1 to access any document that is associated with this policy, even if the user has not purchased rights to use that document. In this example, if user U1 obtains a copy of document D3, e.g. from another user, without having himself purchased the rights to use document D3, when user U1 tries to open document D3, the RMS server will grant the access because D3 is associated with policy P1 to which user U1 has been previously added. In such a scenario, the server is unable to ascertain that user U1 has not purchased the rights to use document D3.

The conventional DRM system typically requires users to purchase documents before downloading them from the system; however, the system is unable to enforce the purchase requirement in certain situations such as that described above.

Commonly-owned US Pat. Appl. Pub. No. 20140282842A1 (published Sept. 18, 2014) describes a “user-centric” approach that can be used to solve the above problem. Under the user-centric approach, the DRM database stores an association table that specifically defines the rights of each user to access each document. Thus, for example, if user U1 has different rights with respect to documents D1 and D3, such rights are specifically defined in the DRM database and can be enforced.

Embodiments of the present invention provide a method that can not only prevent a user from accessing a document in a normal manner unless he has properly acquired the access rights, but also provide the user with well-controlled and limited “trial access” rights to review and/or sample the document before purchase. This can help the user determine whether to purchase the normal access rights.

More specifically, embodiments of the present invention provide a method that allows a user to obtain a document without purchasing the rights to use it, e.g. by obtaining a copy from another user or downloading it from a server, but the user will only be given limited access to the document so obtained, and normal access will be allowed only after the user purchases the document. In embodiments of the invention, the user's trial access to the document can be in various forms, such as: the user can view the document for a limited trial period, or view the document for a limited number of times, or see only a limited number of pages of the document such as the abstract or a summary page. After purchasing the document, the user will acquire the purchased rights such as viewing the entire document any number of times during any time period.

Note that in this disclosure, “normal access” refers to the access rights that the user acquires after fully complying with the DRM systems requirements such as the purchasing requirement, while “limited access” or “trial access” refers to certain limited access rights that the user is given before fully complying with the DRM systems requirements. It should be noted that “normal access” does not means the user has all possible rights to view, print, copy, edit, etc. a document; for example, if the user only purchased the right to view a document, then his normal access right to the document will only include the right to view it. If not specifically indicated, the access rights refers to normal access rights.

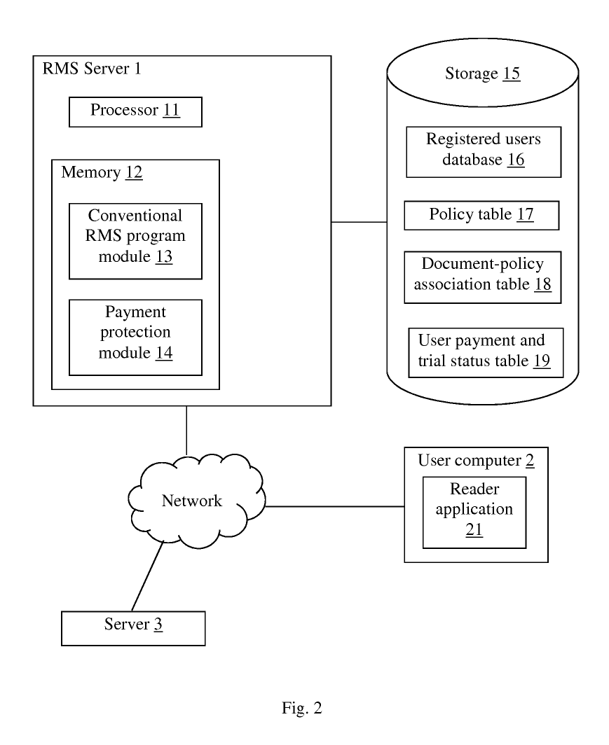

FIG. 2 schematically illustrates a DRM system according to an embodiment of the present invention. The system includes a digital rights management server (RMS) 1 and a user computer 2, and optionally other servers 3 such as a server storing copyrighted digital documents, a server that handles purchases transactions, etc. The RMS server 1 includes necessary hardware including a process 11 and a memory 12. A conventional RMS program module 13 is installed on the server 1 to handle digital rights management functions such as those described in the Background section of this disclosure. A payment protection module 14 is also installed on the RMS server 1 and its functions (described in more detail later) includes to enforce purchase requirements and to manage trial access. Alternatively, the payment protection module 14 may be located on another server such ash server 3.

A storage device 15 coupled to the RMS server 1 stores various database tables maintained and used by the server. These include a policy table 17, a document-policy association table 18, and a user payment and trial status table 19. Other tables may also be stored as a part of the DRM database, such as a registered users table that stores a list of all registered uses and other pertinent information about the users.

The policy table 17, an example of which is shown in FIG. 1A, stores a plurality of rights management policies, each policy specifying which user has what access rights under that policy, as well as other relevant information relating to access rights. The document-policy association table 18, an example of which is shown in FIG. 1B, has one entry for each document being managed by the DRM system (e.g. identified by document ID) and specifies which policy (by policy ID) is associated with that document, as well as other information pertaining to the document such as an encryption key used to encrypt the document.

The user payment and trial status table 19 stores information regarding whether each user has made proper payment for particular documents (identified by document IDs), as well as the trial access status of that user with respect to such documents. In one embodiment, each entry of the user payment and trial status table 19 identifies one user (e.g. by user ID) and one document (e.g. by document ID), and the payment status and trial status for this user with respect to this document.

As mentioned earlier, various trial modes may be implemented. One example is a “trial period” mode, where the user is allowed to access the document for a pre-determined time period (e.g. starting form the first access). If this mode is available, the RMS server will also record the amount of trial time remaining in the user payment and trial status table 19, and periodically update the value of this parameter using the server's time (e.g., subtracting the number of trial days remaining by one at a fixed time every day). Another example of trial mode is a “number of attempts to open” mode, where the user is allowed to open the document for a pre-determined number of times. If this mode is available, the RMS server will also record the number of attempts remaining, and update this parameter every time the user opens the document. Yet another example of trial mode is the “summary view” mode, where the user is allowed to view limited portions of the document such as a summary page, the abstract, or the table of content, etc.

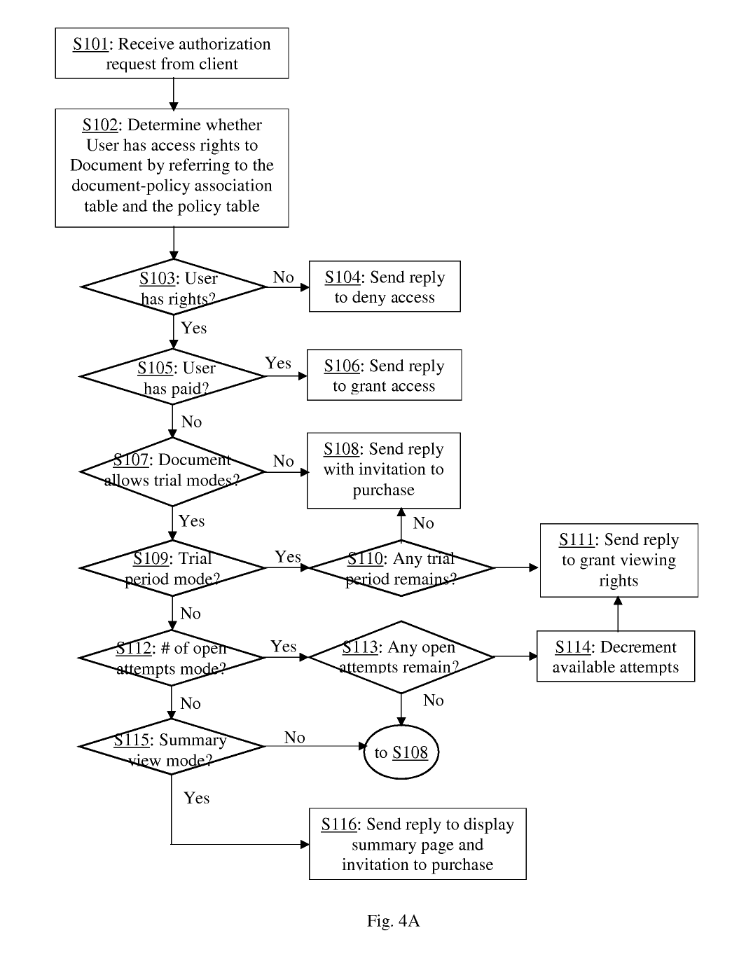

An example of a user payment and trial status table 19 is shown in FIG. 3. In this example, the first three columns from the left are document ID, policy ID, and user ID. The policy ID is the same as that stored in the document-policy association table 19. The remaining columns, from left to right, are:

Payment status (paid or not paid): whether the user has paid for this document. It should be noted that as used in this disclosure, “payment” or “purchase” does not necessarily require a transfer of money. Rather, it refers to the fact that a user has properly obtained the copy of document from the DRM system via prescribed means, as opposed to obtaining a copy from another user without interacting with the DRM system. For example, the DRM system may allow a user to purchase rights to a document for a payment of zero dollars if the user is a member of a recognized group.

Trial period mode availability (yes or no): whether the trial period mode is available for this user with respect to this document.

Number of trial days remaining: the number of trial days remaining for this user with respect to this document under the trial period mode. The server may update this parameter every day based on the server's time. Alternatively, the number of trial days remaining may be replaced by a calendar date that denotes the end of the trial period, so the number of trial days remaining can be calculated dynamically using the server's time.

Number of open attempts mode availability (yes or no): whether the number of attempts to open mode is available for this user with respect to this document.

Number of open attempts remaining: the remaining number of attempts the user is allowed to open the document under the number of attempts to open mode. The server updates this parameter every time the user opens the document.

Summary view mode availability (yes or no): whether the summary view mode is available for this user with respect to this document.

Note that the above data can be stored in any suitable format, not necessarily in tables as shown in FIGS. 1A, 1B and 3. For example, the user payment and trial status table 19 can alternatively be implemented as two tables, one storing user payment information, the other storing the trial status information.

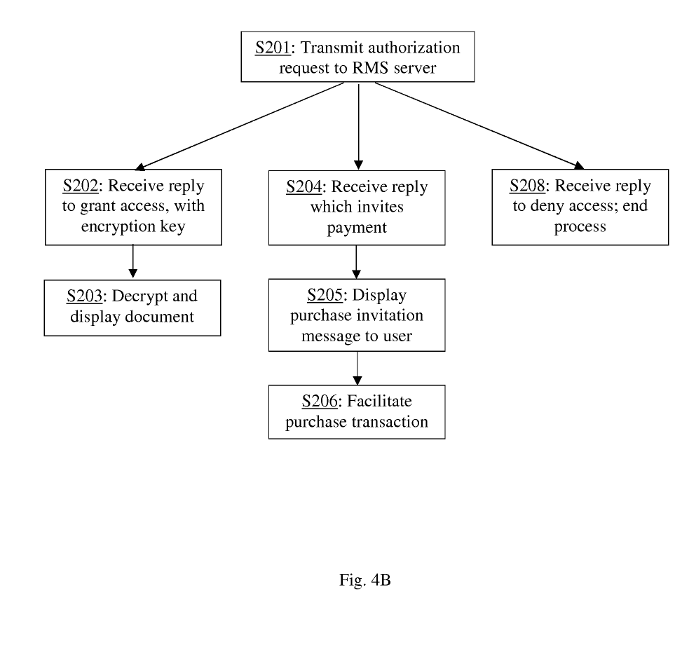

By storing and updating the above data in the DRM database, the RMS server 1 can manage the trial use of documents by users. FIGS. 4A and 4B schematically illustrate a process executed by the RMS server 1 and user computer 2 in cooperation with each other to control access to protected documents. FIG. 4A shows the process steps executed by the RMS server 1, and FIG. 4B shows the process steps executed by the user computer 2.

The process starts when a user tries to open a protected document (i.e. a document managed by the DRM system) using an application program 21 on his computer 2. The application program may be, for example, a document reader application such as Adobe™ Acrobat™. The protected document is encrypted, and the document reader application is configured to cooperate with the DRM system to request permission and necessary keys to decrypt the document. To this end, the user application 21 transmits an authorization request to the RMS server 1, which includes a user ID of the user and a document ID of the document the user is attempting to open (step S201).

The RMS server, upon receiving the authorization request (step S101), first determines whether the user has any access rights under the policy that is associated with the document (step S102). This is done by first referring to the document-policy association table 18 to determine the policy (identified by the policy ID) that is associated with the document (identified by the document ID), and then referring to the policy table 17 to determine whether the user has any rights under that policy. If the result of the determination in step S102 is that the use has no access rights to the document (“no” in step S103), the RMS server 1 sends a reply to the user computer 2 to deny the authorization request (step S104).

As an alternative, the reply transmitted to the user computer in step S104 may be one that includes an invitation to purchase the document, e.g., similar to step S 108, which will be described later.

Steps S102 and step S104 (via the “no” branch of step S103) are similar to steps performed in the conventional DRM system described in the Background section. These steps may be performed by the conventional RMS program module 13 in the server 1. In the conventional DRM system, if the determination in step S103 is affirmative, then the server would transmit a reply to the user computer to grant access to the document. The RMS server 1 in embodiment of the present invention, on the other hand, performs further steps S105 to S116 when the result of the determination in step S103 is “yes,” i.e. when it is determined that the user has access rights to the document. These steps may be performed by the payment protection module 14 of the RMS server 1.

In step S105, the server checks the user payment and trial status table 19 to determine whether the user has paid for (purchased) the document. Note that if the user has not purchased the document and has not previously attempted to open the document, then the user payment and trial status table 19 may not contain an entry containing the particular document ID and user ID. In such a situation, step S105 will include a sub-step of adding an entry to the user payment and trial status table 19 containing the document ID and user ID. The payment status column of this new entry will be set to “not paid” at this time. The other parameters concerning trial modes can be set according to administrative rules, which may take into account the nature of the document, the status of the user, etc.

In step S105, if it is determined that the user has paid for the document, the RMS server 1 transmits a reply to the user computer 2 to grant viewing right to the document, along with the necessary keys to decrypt the document (step S106). The user computer 2 can then decrypts the document and makes it available for the user for viewing, printing, etc. depending on the specific rights that are granted (see FIG. 4B, step S203).

If the user has not paid for the document (“no” in step S105), the RMS server 1 further determines whether the document is one for which trial mode is implemented (step S107). Some documents may not allow any trial mode at all. The information about whether a document allows any trial mode at all may be stored in the user payment and trial status table 19. If the document does not allow for any trial mode (“no” in step S107), the RMS server 1 transmits a reply to the user computer 2 to invite the user to purchase rights to access the document (step S108). This would cause the user computer 2 to display a message to inform the user that he has not purchased rights to access the document and ask the user whether he would like to purchase the rights. Alternatively, the RMS server may simply transmit a reply to the user computer to deny the authorization request without the invitation to purchase, similar to step S104. Note that step S107 is optional; separately checking for each trail mode accomplishes the same result if the document does not allow any trial mode.

If the document is one that allows for trial mode (“yes” in step S107), the server determines whether a “trial period” mode, a “number of open attempts” mode, or a “summary” mode, respectively, is available (steps S109, S112, S115). This is done by referring to the user payment and trial status table 19. If the trial period mode is available (“yes” in step S109), the server further determines whether any trial period remains, again by referring to the user payment and trial status table 19 (step S110). If some trial period still remains, the server transmits a reply to the user computer 2 to grant viewing right to the document (step S111); otherwise the server transmits a reply to the user computer to invite the user to purchase rights to access the document (step S108). Note that the rights granted in step S111 preferably only includes a viewing right, so the user is not allowed to print, copy, or edit the document during trial use.

If the number of open attempts mode is available (“yes” in step S112), the server further determines whether any number of open attempts remain, by referring to the user payment and trial status table 19 (step S113). If a number of open attempts still remain (“yes” in step S 113), the server decrements the number of remaining open attempts stored in the user payment and trial status table 19 (step S114), and transmits a reply to grant viewing right to the user computer (step S111). Otherwise, the server transmits a reply to the user computer to invite the user to purchase access rights to the document (step S108).

If the summary view mode is available (“yes” in step S115), the server transmits a reply to the client which will cause the client to displays a summary page of the document and an invitation to purchase rights to the document (step S116). The summary page may be pre-generated as a page of the PDF document prior to distribution, or it may be stored on or dynamically generated by the server and sent to the client with the reply.

If none of the trial modes are available (“no” in steps S109, S112, and S115), the server transmits a reply to the user computer to invite the user to purchase rights to access the document (step S108).

On the user computer 2 (see FIG. 4B), after transmitting the authorization request (step S201), a number of different replies may be received from the server. If the reply is one that grants the access (step S202), corresponding to the reply in step S106 and S111 of FIG. 4A, the user computer decrypts the document using the key received from the server, and displays the document or otherwise makes the document available to the user based on the type of rights granted by the server (step S203). If the reply from the server is a simple denial of access, no further steps will be performed and the document reader application on the user computer will not open the document. On the other hand, if the reply is one that invites the user to purchase the access rights (step S204), corresponding to the reply in step S108 of FIG. 4A, the user computer will display a message to the user advising him that he does not have access rights to the document and invites him to purchase the right (step S205). The message preferably includes a link that will direct the user to a purchase page, to facilitate the purchase transaction should the user chose to purchase the rights (step S206). Steps S204 to S206 may be accomplished in any suitable manner, for example by using a web browser to interact with the user. Either the RMS server 2 or a separate server (e.g. server 3) may be used to conduct the purchase transaction, and any suitable techniques may be used to accomplish the transaction. After the purchase is complete, the RMS server 1 updates the policy table 17 and the user payment and trial status table 19 to reflect the fact that the user has purchased the rights to access this document. The document can now be accessed by the user.

A document reader application adapted to perform functions under the conventional DRM system can perform steps S201, S202, S203 and S208. The steps S204, S205 and S206 pertaining to message display and purchase transaction may be implemented using a web browser on the user computer; in which case the method shown in FIG. 4B may be implemented without modifying the conventional document reader application. Alternatively, the message displays may be done in a window of the document reader application 21, in which case the conventional reader application may be modified (e.g. by using plug-ins or other modifications) to implement such functions.

To summarize, embodiments of this invention provide server-based enforcement of access rights to provide limited (trial) or normal access based on payment status and available trial modes.

The method can validate payment status and authorize normal access to documents once the user purchases the access rights, thus allowing content distributors to control access to document to ensure that only after paying for the document can users gain normal access to it.

In addition to preventing access to documents that have been obtained without authorization, the methods described here can also be used to support a document distribution scheme by which digital documents can be freely distributed without requiring users to pay for them first. Such documents can be locally stored on the user's computer, but are locked in the sense that the user does not have normal access to the documents. The method described here can be used to give users limited trial access to the documents before they purchase them; the trial access can provide an opportunity for the user to try and then decide whether they wish to purchase the documents.

The trial use method implemented in embodiments of the present invention is different from known trial use methods used by some evaluation versions of software applications. For example, some software programs allow users to download the application and use it for duration for evaluation period; after evaluation period the software becomes unusable. In such cases, the software depends on the user computer's local time to decide when the evaluation period is completed. One limitation with such a method is that users can set the clock of his computer back to some past time and then keep using the software. This way users can overcome the evaluation period limitation and keep using the software indefinitely. The “trial period” mode implemented in embodiments of the present invention, on the other hand, checks the clock at the RMS server when determining the remaining trial period. This prevents the user from setting back the clock to continue to use the evaluation version. In another example, some software applications have trial versions that control how many times user can do something. The number of attempts remaining is stored locally in the software at the user's computer. To overcome such limitation, a user can uninstall and reinstall the software, and the number of attempts is reset. In the “number of attempts” mode implemented in embodiments of the present invention, the number of attempts remaining is stored at the server and there is no way for the user to reset it.

It will be apparent to those skilled in the art that various modification and variations can be made in the digital rights management method and related apparatus of the present invention without departing from the spirit or scope of the invention. Thus, it is intended that the present invention cover modifications and variations that come within the scope of the appended claims and their equivalents.

What is claimed is:

1. A digital rights management method implemented in a server computer for managing access to digital documents, comprising:
(a) storing and updating user payment and trial status data, which indicates, for each of a plurality of digital documents with respect to one or more of a plurality of users, whether each user has purchased access rights to the document, whether one or more trial modes are available to the user and if available, whether any trial access right remains for the user under the available trial mode;
(b) receiving a authorization request from a client computer containing a user ID of a user and a document ID of a document requested to be accessed by the user;
(c) determining whether the user has purchased access rights to the document by referring to the user payment and trial status data using the document ID and the user ID in the authorization request;
(d) if the user has purchased access rights to the document, transmitting a reply to the client to grant access to the document;
(e) if the user has not purchased access rights to the document, determining whether one or more of the trial modes are available to the user and if available, whether any trial access right remains for the user under the available trial mode;
(e) if one or more of the trial modes are available to the user and some trial access right remains for the user, transmitting a reply to the client to grant a right to the document permitted under the available trial mode; and
(f) if no trial mode is available to the user or no trial access right remains for the user, transmitting a reply to the client to display to the user an invitation to purchase access rights to the document.

2. The method of claim 1, wherein the trial modes include a trial period mode under which the user is granted access to view the document for a pre-determined time period,

3. The method of claim 2, wherein the trial modes include a number of attempts to open mode under which the user is granted access to view the document for a pre-determined number of times.

4. The method of claim 3, wherein the trial modes include a summary view mode under which the user is granted access to view a predetermined portion of the document.

5. The method of claim 4, wherein in step (e), if the trial period mode and the number of attempts to open mode are not available and the summary view mode is available, the server further transmits an additional message to the client to display to the user an invitation to purchase access rights to the document.

6. The method of claim 1, wherein the server further stores policy data including a plurality of rights management policies, each policy specifying one or more users and the access rights they have under that policy, and
wherein the server further stores document-policy association data which specifies, for each of a plurality of digital documents, the policy that is associated with the document.

7. The method of claim 6, further comprising, before step (c):
(g) determining whether the user has any access rights under the policy associated with the document, by referring to the document-policy association data and the policy data, and
(h) if the user has no access rights to the document, transmitting a reply to the client to deny the authorization request,
wherein steps (c)-(f) are performed only if the user is determined to have access rights in step (g).

8. A computer program product comprising a computer usable non-transitory medium having a computer readable program code embedded therein for controlling a server, the computer readable program code configured to cause the server to execute a digital rights management process for managing access to digital documents, the process comprising:
(a) storing and updating user payment and trial status data, which indicates, for each of a plurality of digital documents with respect to one or more of a plurality of users, whether each user has purchased access rights to the document, whether one or more trial modes are available to the user and if available, whether any trial access right remains for the user under the available trial mode;
(b) receiving a authorization request from a client computer containing a user ID of a user and a document ID of a document requested to be accessed by the user;
(c) determining whether the user has purchased access rights to the document by referring to the user payment and trial status data using the document ID and the user ID in the authorization request;
(d) if the user has purchased access rights to the document, transmitting a reply to the client to grant access to the document;
(e) if the user has not purchased access rights to the document, determining whether one or more of the trial modes are available to the user and if available, whether any trial access right remains for the user under the available trial mode;
(e) if one or more of the trial modes are available to the user and some trial access right remains for the user, transmitting a reply to the client to grant a right to the document permitted under the available trial mode; and
(f) if no trial mode is available to the user or no trial access right remains for the user, transmitting a reply to the client to display to the user an invitation to purchase access rights to the document.

9. The computer program product of claim 8, wherein the trial modes include a trial period mode under which the user is granted access to view the document for a pre-determined time period,

10. The computer program product of claim 9, wherein the trial modes include a number of attempts to open mode under which the user is granted access to view the document for a pre-determined number of times.

11. The computer program product of claim 10, wherein the trial modes include a summary view mode under which the user is granted access to view a predetermined portion of the document.

12. The computer program product of claim 11, wherein in step (e), if the trial period mode and the number of attempts to open mode are not available and the summary view mode is available, the server further transmits an additional message to the client to display to the user an invitation to purchase access rights to the document.

13. The computer program product of claim 8, wherein the server further stores policy data including a plurality of rights management policies, each policy specifying one or more users and the access rights they have under that policy, and
wherein the server further stores document-policy association data which specifies, for each of a plurality of digital documents, the policy that is associated with the document.

14. The computer program product of claim 13, wherein the method further comprises, before step (c):
(g) determining whether the user has any access rights under the policy associated with the document, by referring to the document-policy association data and the policy data, and
(h) if the user has no access rights to the document, transmitting a reply to the client to deny the authorization request,
wherein steps (c)-(f) are performed only if the user is determined to have access rights in step (g).
